(19) United States
(12) Patent Application Publication
(10) Pub. No.: US 2008/0016058 A1
(43) Pub. Date: Jan. 17, 2008

(54) Multi-candidate, multi-criteria decision-making method

(75) Inventors: Kenneth S. Murphy, Williamsburg, VA (US); Thomas A. Michaelson, Cambridge, MA (US)

Correspondence Address: PETER J. VAN BERGEN, 402 WEST DUKE OF GLOUCESTER STREET, WILLIAMSBURG, VA, 23185, US

(73) Assignee: DECISION HELP, LLC

(21) Appl. No.: 11/827,556

(22) Filed: Jul. 12, 2007

Related U.S. Application Data
(60) Provisional application No. 60/830,643, filed on Jul. 13, 2006.

(51) Int. Cl. G06F 7/60; G06T 11/20

(52) U.S. Cl. 707/5; 345/440.2; 707/E17.017

(57) ABSTRACT

A method of identifying a best candidate from a plurality of candidates that are to be evaluated according to a plurality of criterions is provided. For each of the candidates, at least two grades are established for each criterion associated therewith. For each of the candidates, at least two weighted sums are then generated. The weighted sums are presented for at least one of the candidates.

### ORIGIN OF THE INVENTION

Pursuant to 35 U.S.C. §119, the benefit of priority from provisional application 60/830,643, with a filing date of Jul. 13, 2006, is claimed for this non-provisional application.

### FIELD OF THE INVENTION

The present invention relates to multi-criteria decision analysis (MCDA). More particularly, the invention relates to MCDA where a user (human or otherwise) is seeking to choose between multiple candidates based upon the individual performances of the candidates when measured by multiple criterions.

### BACKGROUND OF THE INVENTION

Multi-criteria Decision Analysis (MCDA) involves making decisions in an environment where there are multiple criterion and multiple candidates. A candidate is one of at least two options to choose between or to assign a preference ranking to as a result of the decision process. A criterion is one of the measures against which candidates are assessed and compared. For example and without limitation, many decisions have criteria such as “Price”, “Quality”, etc. A weight is a value that is associated with a particular criterion. Each criterion normally has a weight, whose value is normally assigned by the user. The weight represents the level of importance that the user places upon that criterion. Highly weighted criteria are more important than lightly weighted criteria. Weights must be able to be mapped onto a numeric value for later computation.

In MCDA, candidates are graded on the various criteria. In prior art MCDA, a grade is a single value that can be known, estimated, guessed, selected from a range of values, or selected from a distribution function associated with a particular criterion and a particular candidate. A grade can be assigned by the user or an automated system. Its purpose is to indicate how well a particular candidate meets a particular criterion. High grades indicate that the particular candidate meets the particular criterion well; low grades indicate that the particular candidate meets the particular criterion poorly. Grades generally are able to be mapped onto a numeric value for later computation. A grade list is a collection of related grades for a particular candidate. The grade list contains a single entry (or “slot”) for each criterion. That single entry is traditionally the value of the grade for that particular criterion and that particular candidate. All current MCDA approaches support only one grade list per candidate. These grades are translated into a score for each candidate. A score is a computed value associated with a particular candidate and a particular grade list. It is calculated by multiplying the numeric equivalent of each criterion's weight by the numeric equivalent of the candidate's grade in this grade list, and summing them all together, i.e., a weighted sum. High scores indicate that the particular candidate meets the criteria well, and low scores indicate that the particular candidate meets the criteria poorly.

The decision scenario is the combination of the criteria, associated weights, candidates and associated grades and scores of a particular decision instance. The user of MCDA may be a human accessing the method via a human-computer interface or by way of non-computer based systems, or the user may be some sort of automated process.

The current basic approach to multi-criteria, multi-candidate decision making has been around since at least the 1970s. FIG. 1 is a flow chart illustrating exemplary steps to a current approach to MCDA. This prior art approach involves (roughly) the following steps, not necessarily in the order listed. To begin, the user constructs or updates the decision scenario by entering or updating candidates, criteria and or weights in step 1-2. Note that throughout this process all grades for new candidates or criterion are initially given some sort of default value. The user checks if all of the grades have been entered in step 1-4. If not, the user continues to step 1-6 where the user enters a grade. When finished, the user may modify or add one or more candidate(s), criterion, weight(s) or previously entered grade in step 1-8. After step 1-8 the user returns to step 1-4 to verify that all of the grades have been entered. If so, the method proceeds to step 1-10. In step 1-10 the score for each candidate is calculated or updated. At this point, the user may modify or add one or more candidate(s), criterion, weight(s) or previously entered grades at step 1-12 and go back to the grade-entering loop at step 1-4. If no modifications are made, the method goes to step 1-14 where candidates are ranked in descending order by score. Step 1-16 gives the user another opportunity to modify or add one or more candidate(s), criterion, weight(s) or previously entered grades and go back to the grade-entering loop at step 1-4. In step 1-18, the N candidates ranked first represent the N best candidates for the decision scenario. Finally, in step 1-20, the user may choose to re-evaluate criteria, candidates, weights, and grades, and may do sensitivity analysis.

FIG. 2 shows a sample drawing of prior art MCDA being applied to choosing a college. The identifiers, or names, for the relevant criteria of a decision are listed along one axis of what is in effect a two dimensional table, and weights are assigned to each criterion. The identifiers of candidates are listed along the other axis of the table. Grades for a particular criterion and a particular candidate are determined and then entered by the user at the intersection of the criterion's row and candidate's column. In current uses of MCDA, only one grade list is supported per candidate. Grades that have not been entered are assumed to be some approximated value, such as, but not limited to, low, average or high values, or some distribution. At any time the user may compute the candidate's score based upon the grades currently applicable for that candidate. Also, at any time the user may compare current scores and choose which candidate “wins” the decision, thereby stopping the decision-making process. Generally, the user enters the majority or all of the grades before choosing a winning candidate. The candidate with the highest score is the most likely to be chosen as the winning candidate.

The current basic approach may be widely found in prior art in numerous places, including: “Introduction to Decision Analysis”—1978. ISBN 0-87872-144-4, Chapter 13 “Multicriteria Decisions” and “Spreadsheet Modeling and Decision Analysis”—2001. ISBN 0-324-0212204 Chapter 15 “Decision Analysis”. The website www.logicaldecisions.com offers a commercial-off-the-shelf software package that uses the basic approach, and the website www.DecisionHelper.com offers software from which the screen capture shown in FIG. 2 was taken. This approach is also described in the following works: (i) “Decisions With Multiple Objectives: Preferences and Value Tradeoffs” by R. L. Keeney et al., John Wiley, 1976, (ii) “Theory of Games and Economic Behaviour, Second Edition” by J. Von Neumann et al., Princeton University Press, 1947, and (iii) on the website http://www.catalyze.co.uk/mcamanual_body.html (see especially the discussion of Outranking in Appendix 6).

When applying current state of the art MCDA approaches to decisions, users may experience some significant shortcomings. The first problem is that there may be difficulty in determining the N optimal candidate(s) when grades are missing because the data for that grade was unavailable, difficult to get or difficult to analyze. One of the main goals of MCDA is to enable an “apples to apples” comparison between candidates. This is achieved by compiling all grades for a candidate across many different criteria into a single score that can then be compared with the corresponding scores of other candidates in a straightforward manner. However, if any grade for a particular criterion-candidate combination is unknown and is therefore omitted or approximated, the “apples to apples” comparison ability is degraded, and the amount of degradation is difficult to quantify. For example, suppose that a user has a decision scenario with two candidates and five criteria. If the user is able to research and assign five grades to each candidate (one for each criterion), all is well. However, if one candidate has an unknown for a grade, the user must choose between one of the following options. The user may choose not to use the MCDA method, which may not be an attractive option. The user may assume a value for the missing grade and compute the scores anyway, which may produce sub-optimal or misleading results. The user may omit the corresponding grade(s) for the same (or another equally weighted) criterion for the other candidate(s) grade and compute the scores anyway, which is a willful overlook of information which may produce sub-optimal or misleading results. The user may approximate the missing grade and compute the scores anyway, which may produce sub-optimal or misleading results. The user may do additional research to supply the missing grade(s), which may require resources, such as time and money, out of proportion to the value of the grade itself so that the user may end up doing additional research because MCDA demands it rather than because the data and the subsequent grade itself is that important. Finally, the user may use “Outranking”, as described in current literature, which is difficult to understand and execute, and may not actually apply. However, each of these options reduces the value of the MCDA method.

Another problem is that the user may have to perform a large amount of research to assign more grades simply because there is no clear stopping condition other than the assignment of all grades. When researching and assigning grades one by one using MCDA, it may be possible to determine the ultimate answer based upon the data and grades already supplied. But there is no clear and definitive way to know that this is the case, much less to know what the answer actually is. Therefore, the user often ends up doing the required research to assign more grades than are really necessary and, perhaps, each and every grade. In many situations this may be wasteful and inefficient.

Another problem is deciding in what order the grades should be researched and assigned. There may be an optimal ordering by which grades should be researched and assigned so that the total number of grades which must be researched and assigned is minimized. Current methods have no way of determining if there is an optimal order or, if there is an optimal order, what that optimal order should be. In current approaches users enter grades in whatever order is convenient for them.

Another problem is that intuition cannot be taken into account during conventional MCDA decision making. Traditional MCDA approaches ignore abstract criteria such as, but not limited to, intuition, gut feeling, and “personal chemistry”. This may produce sub-optimal results because the results of MCDA are often balanced against intuition after running the MCDA process. The only way to integrate these criteria into traditional MCDA is to consider them independently from the MCDA process. Finally, how does a user motivate self-discovery, insight and introspection in someone facing a complex situation that may or may not require a decision? Insight and self-discovery can be assisted by systematic, detailed analysis of a situation. MCDA is not currently used for this purpose.

Currently, users merely tolerate these deficiencies by researching and entering all grades in order to have access to definitive results, even if those grades have to be approximated or estimated. In other words, instead of coming up with an algorithmic method that allows the user to derive a definitive answer in spite of missing data, users have focused on ways of estimating or approximating the values of missing data. Applications of MCDA have been used traditionally in business or public sector areas where the presence of missing data is less acceptable, but where there are resources for researching and assigning missing data. Consumers have rarely used this approach because they typically lack research resources. Intuition has traditionally been balanced against MCDA results after running the MCDA process, i.e., as a part of the final decision making step.

### SUMMARY OF THE INVENTION

Accordingly, it is an object of the present invention to provide an improved method of MCDA that can reach a decision without assigning grades to all of the criteria.

Another object of the present invention is to provide an improved method of MCDA that reduces the amount of investigation required to reach an optimal decision.

Other objects and advantages of the present invention will become more obvious hereinafter in the specification and drawings.

In accordance with the present invention, a method is provided to identify a best candidate from a plurality of candidates that are to be evaluated according to a plurality of criterions. A weight is provided or calculated for each criterion. For each of the candidates, at least two grades are established for each criterion associated therewith. For each of the candidates, at least two weighted sums are generated using the weight and the grades for each of the criterions. The weighted sums are then presented for at least one of the candidates to an end user. The method supports the use of two different grades for a candidate/criterion. If the grades for a candidate/criterion are unknown, the grades are initialized and retained in a default condition defining a best-case/worst-case scenario that (i) is used to determine the optimal candidate, and (ii) can further be used to identify the optimal candidate/criterion grade that should be researched to establish known grades for a more effective decision making process.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a flow chart illustrating exemplary steps for a prior art approach to MCDA;

FIG. 2 illustrates a sample screen capture generated by a prior art MCDA process applied to choosing a college;

FIG. 3 is a process flow chart of exemplary steps for a MCDA process in accordance with an embodiment of the present invention;

FIG. 4 is a process flow chart showing exemplary details of the determination of the N most optimal candidates in accordance with an embodiment of the present invention;

FIG. 5 is a process flowchart that shows the details of an exemplary method that minimizes the number of grades that must be researched and assigned in order to achieve the user's objective of definitively determining the N most optimal candidates in accordance with an embodiment of the present invention;

FIG. 6 is a block diagram of an embodiment of a system for carrying out the present invention; and

FIG. 7 illustrates an exemplary screen capture from a program performing MCDA with the addition of best-case and worst-case tracking in accordance with an embodiment of the present invention.

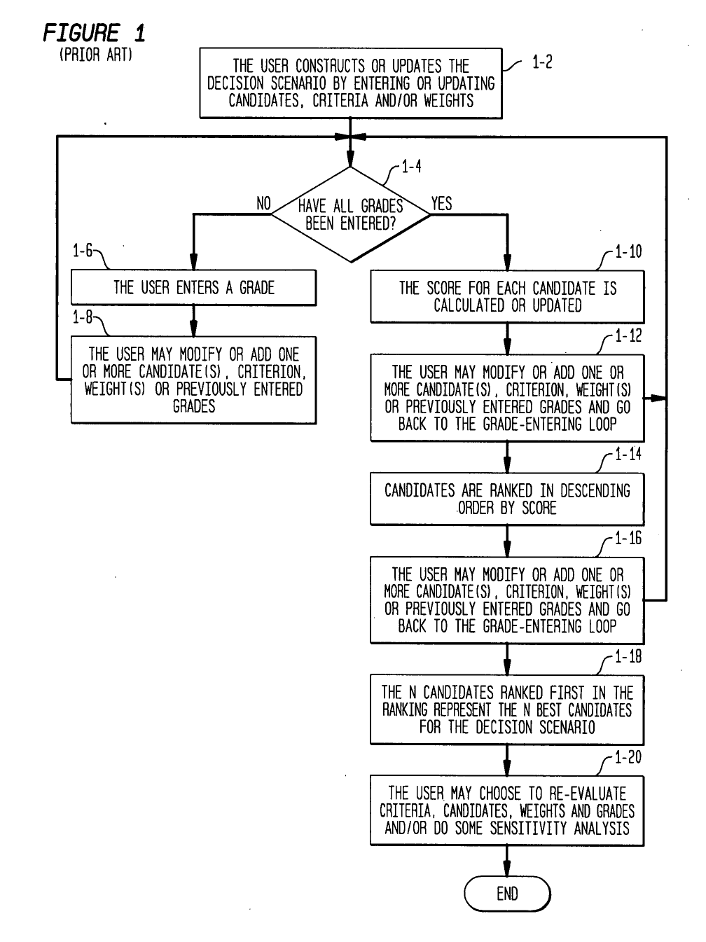

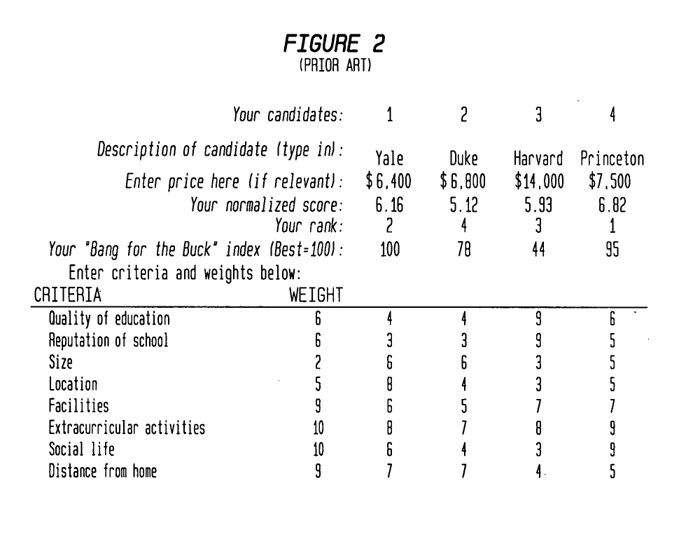

### DETAILED DESCRIPTION OF THE INVENTION

Embodiments of the invention are discussed below with reference to the figures. However, those skilled in the art will readily appreciate that the detailed description given herein with respect to these figures is for explanatory purposes as the invention extends beyond these limited embodiments. For example, without limitation, it should be appreciated that those skilled in the art will, in light of the teachings of the present invention, recognize a multiplicity of alternate and suitable approaches, depending on the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive. The present invention will now be described in detail with reference to embodiments thereof as illustrated in the accompanying drawings.

An aspect of the present invention is to make MCDA more usable for all who may benefit from MCDA including, but not limited to, consumers, the public sector, and business users. As used herein, the term “user” refers to human users as well as automated applications or systems that provide information to the present invention and/or use the information generated by the present invention. Embodiments of enhanced MCDA in accordance with the present invention are generally more amenable to consumer and personal use than current MCDA approaches are. Another aspect of the present invention is to reduce the total amount of work required to use MCDA to realize a decision solution. Solutions can be found faster, easier (i.e., using fewer resources), or both faster and easier.

Embodiments of the present invention provide an enhanced approach to MCDA that allows users to find the N most optimal candidates, even when some grades are unassigned. This makes MCDA much more usable in the real world where data is not always easily available for assigning grades, where the cost of assigning grades may be prohibitive, and/or where approximating or estimating grades may be unacceptably risky. Furthermore, some embodiments include a heuristic that often reduces the total number of grades that must be researched and assigned. MCDA in accordance with the present invention can be applied to an incredible variety of decision scenarios including, but not limited to, vendor selection, medical decisions, the location of oil refineries, what breed of dog to get, which car to purchase, what college to go to, when to have children, which product lines to manufacture, which job offer to accept, etc.

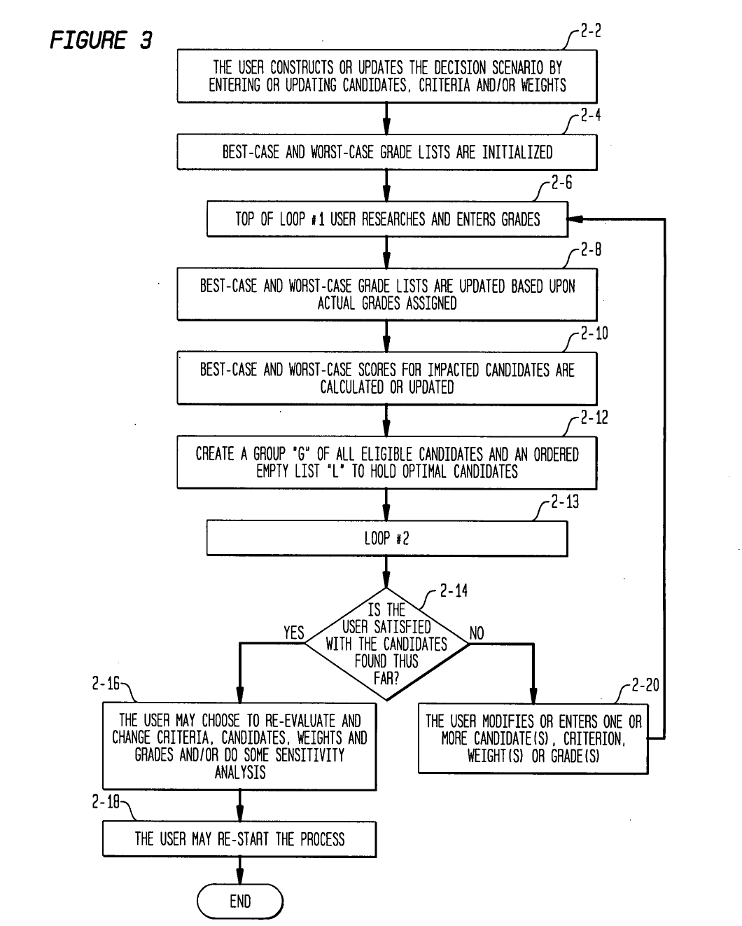

FIG. 3 is a process flow chart of exemplary steps taken in an enhanced MCDA process in accordance with an embodiment of the present invention. The present embodiment of the enhanced MCDA approach involves the steps shown by way of example in FIG. 3, not necessarily in the order listed. In general, the user wishes to definitively determine the N (0<N<=max number of candidates) most optimal candidates and list them in order of descending optimality. For example, without limitation, for N=1, only the best candidate will be found, and for N=3, the three most optimal candidates will be found and listed in order of descending optimality.

Briefly, the user starts with a traditional MCDA decision method. However, instead of supporting only one grade list per candidate, the present embodiment supports at least two grade lists per candidate. By way of a non-limiting illustrative example, the present invention will be described for two grade lists per candidate, one for the worst-case grades and one for the best-case grades. Also, instead of supporting only one score per candidate, the present embodiment supports at least two scores per candidate corresponding to the number of grade lists. Thus, for the illustrative example, each candidate will have a worst-case score and a best-case score. The present embodiment allows users to definitively determine the optimal N candidate(s) even when some grades are missing by intelligently comparing the worst-case scores and best-case scores of all candidates each time such scores are recalculated or updated.

Referring now to FIG. 3, the present invention begins with step 2-2 where the user constructs or updates the decision scenario by entering or updating candidates, criteria and/or weights. Although not a requirement, this and the remaining steps of the present invention are typically carried out on a processing platform that includes a computer. The grades for new candidates or criterion are initially given a default value according to the following rule. The default grade for grades in the worst-case grade list is the worst possible grade for the corresponding criterion. The default grade for grades in the best-case grade list is the best possible grade for the corresponding criterion. Providing the initial grade lists can be accomplished in a variety of ways without departing from the scope of the present invention. For example, the grade lists could be manually entered by a user, stored on a memory device, etc. However, the actual creation and storage of grade lists is not required for this embodiment, since these grade lists may be calculated from the original grades on demand. When the present invention is implemented using a typical processing platform, the best-case and the worst-case lists are initialized to their default values in step 2-4. The default grade for grades in the worst-case grade list is the worst possible grade for the corresponding criterion, and the default grade for grades in the best-case grade list is the best possible grade for the corresponding criterion. Step 2-6 is the top of Loop #1, which includes researching and entering grades.

In step 2-8, assigned grades (i.e., grades that are known) are used to update the best-case grade list and the worst-case grade list. The actual creation and storage of grade lists is not required for this embodiment, since these grade lists may be calculated from the original grades on demand. If the grade is a known single value, that value is assigned to both the best-case grade list slot and the worst-case grade list slot for that candidate and criteria. If the grade is a known grade range or distribution, the worst grade in that range or distribution is assigned to the corresponding entry in the worst-case grade list and the best grade in that range or distribution is assigned to the corresponding entry in the best-case grade list. Once a grade is known/assigned, the grade is no longer considered to have a default value “status”. Accordingly, when implementing the present invention on a processing platform, a grade status “flag” can be used to indicate that a particular grade is a default/unassigned grade or a known/assigned grade.

In step 2-10, the best-case and worst-case scores for impacted candidates are calculated or updated. The worst-case and best-case scores for each candidate impacted by any user action are calculated or updated using the common weighted sum approach. That is, each grade's numeric value is multiplied by the grade's corresponding criterion's weight, and the results are summed into a score (i.e., a weighted sum) for the candidate. The actual creation and storage of scores is not required for this embodiment, since these scores may be calculated from the grade lists or the original grades on demand. Note that changes to weights or the addition of new criteria impact all of the candidates' scores, while the changing of a grade or the adding of a new candidate impacts only one candidate's scores.

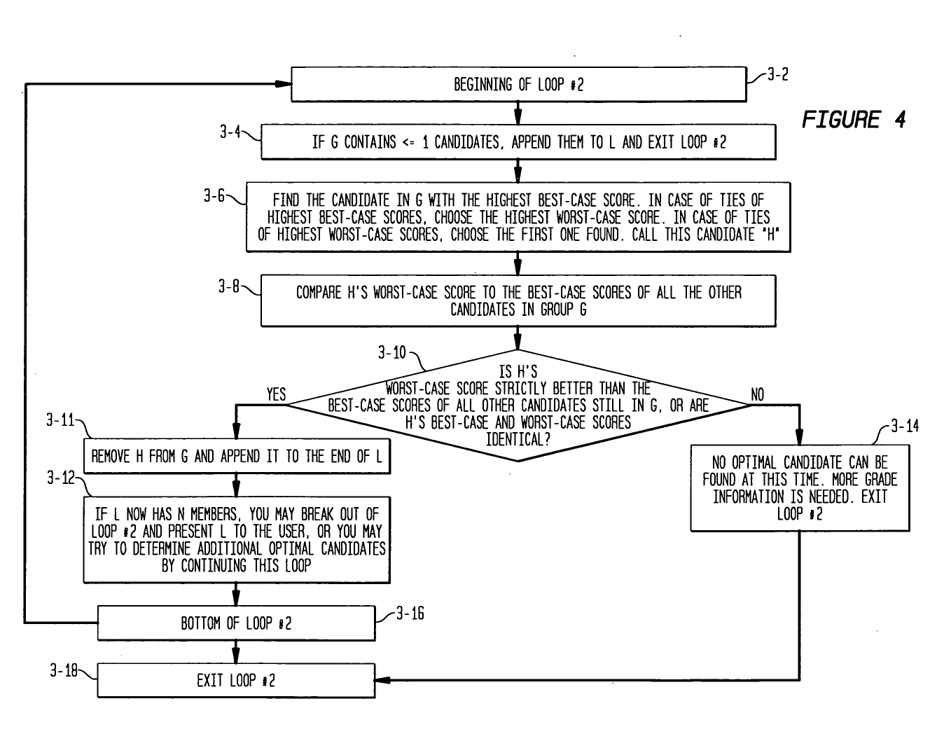

The present method next determines the desired N most optimal candidates and lists them in descending order by optimality. In step 2-12, a grouping “G” of all candidates is created. This grouping may or may not be presorted in the order described below as implementations may vary. Also in step 2-12, a real or virtual list “L”, which is initially empty, is created/used to append the optimal candidates as they are found. In the present embodiment, candidates are appended and maintained in their order of decreasing optimality. The method then proceeds to Loop #2 at step 2-13 where the N most optimal candidates are actually determined. The details of the process in Loop #2 illustrated in FIG. 4 will be described in detail further below. When the steps in Loop #2 are complete and the optimal candidates have been determined, the method returns to Loop #1 and continues at step 2-14.

In step 2-14, the user decides if he is satisfied with the candidates. If the user is satisfied with the candidates found thus far, the user exits Loop #1 and goes to step 2-16. In step 2-16, the user may choose to re-evaluate and change criteria, candidates, weights and grades and/or do sensitivity analysis. Then in step 2-18, the user may re-start the process. If the user is not satisfied with the candidates at step 2-14, the user modifies or enters one or more candidate(s), criterion, weight(s) or grades in step 2-20 and the process returns to Loop #1.

FIG. 4 is a process flow chart of Loop #2 illustrating exemplary details of the determination of the N most optimal candidates in accordance with an embodiment of the present invention. In general, Loop #2 finds, if possible, the N best candidate(s). More specifically, Loop #2 begins at step 3-2. At step 3-4, if grouping G contains zero or one candidate, the candidate, if there is one, is appended to list L. In this case, Loop #2 is exited and the user returns to Loop #1 at step 2-14. If grouping G contains more than one candidate, the method proceeds to step 3-6. In step 3-6, the method finds the candidate in grouping G with the highest best-case score. In cases where there are ties of highest best-case scores, the method finds the candidate that also has the highest worst-cast score. In the case of ties at this level, one embodiment of the enhanced method chooses the first one found. If grouping G is presorted, this selection will be easy. The candidate found in this step is called candidate “H”.

In step 3-8, the worst-case score of candidate H is compared to the best-case scores of all of the other candidates in grouping G. If grouping G is presorted, this can be done easily by comparing the score of candidate H with the scores of the next candidate in the sorted order, otherwise the remainder of grouping G will have to be traversed. In step 3-10, it is determined if candidate H's worst-case score is strictly better than the best-case scores of all other candidates still in grouping G. If so, candidate H is the optimal candidate currently in grouping G. If candidate H's worst-case score is not strictly better than the best-case scores of all other candidates still in grouping G, step 3-10 determines if the best-case and worst-case scores of candidate H are identical. If this is the case, candidate H may be tied with another candidate in grouping G for optimality. If either of the previous cases are true, the user proceeds to step 3-11. In step 3-11, candidate H is removed from grouping G and appended to the end of list L. Then, in step 3-12, if list L now has N members, the process can exit Loop #2 and present list L to the user, or the method can be continued to determine additional optimal candidates by continuing on to step 3-16 where the process cycles back to step 3-2. In the preferred embodiment, if candidate H is potentially tied with another candidate still in grouping G, the loop is continued. If neither of the questions presented in step 3-10 can be answered yes, the method proceeds to step 3-14. In step 3-14, the process assumes that no additional optimal candidate(s) can be found at this time, and that more grade information may be required to make a definitive determination. Therefore, Loop #2 is exited.

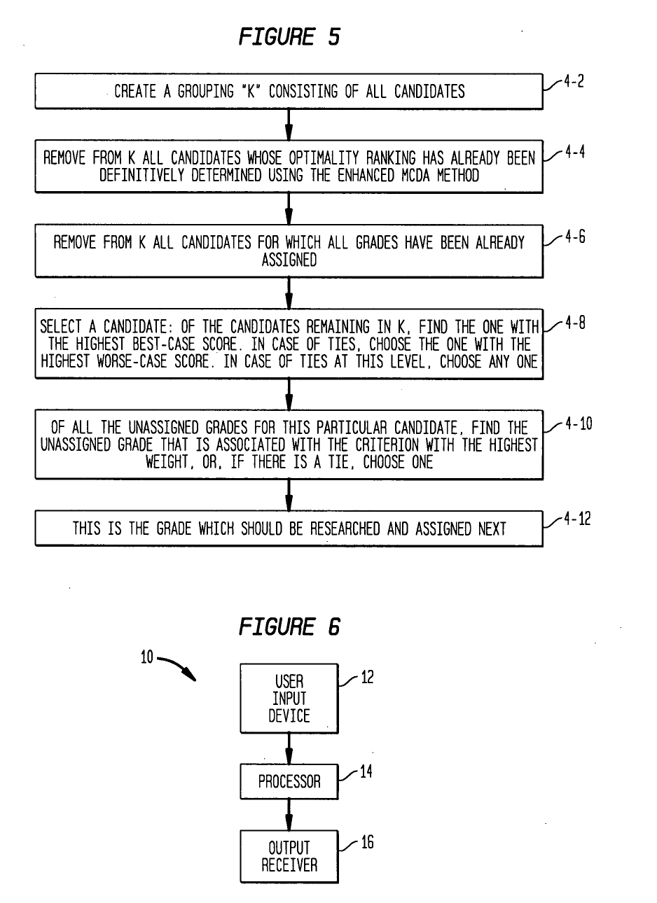

FIG. 5 is a process flowchart that shows the details of an exemplary method that minimizes the number of grades that must be researched and assigned in order to achieve the user's objective of definitively determining the N most optimal candidates in accordance with an embodiment of the present invention. The minimization of the number of grades that must be researched and assigned potentially saves the user resources such as, but not limited to, time and money, by potentially minimizing the effort needed in order to achieve the user's objective.

When the user must research and assign a grade during the course of using an enhanced MCDA method according to the present embodiment, the optimum grade (associated with a particular criterion for a particular candidate) to research and assign at that point should be chosen in the following fashion. First, in step 4-2, a grouping “K” is created comprising all of the candidates. Then in step 4-4, all candidates whose optimality ranking has already been definitively determined using the enhanced MCDA method are removed from grouping K. Then in step 4-6, all candidates for which all grades are known and have already been assigned are removed from grouping K. Of the candidates remaining in grouping K (i.e., those having at least one criterion with its two grades still defined by the default values described above), the one(s) with the highest best-case score are found in step 4-8. In the case of ties, the candidate with the highest worst-case score is chosen. In case of ties at this level, any one of the tying candidates may be chosen. In step 4-10, the unassigned grade that is associated with the criterion with the highest weight from all of the unassigned grades for this particular candidate is found. If there is a tie, any of the tying grades may be chosen. This is the grade which should be researched and assigned next in step 4-12. That is, researching the associated criterion for the associated candidate in order to assign a grade thereto has the greatest potential for reducing the best-case score and raising the worst-case score of the candidate with the greatest potential of being the most optimal candidate in grouping K. Therefore, this grade is the most likely grade to result in confirming or degrading the optimality of the most promising candidate. Determining this most influential grade and directing the user to, if possible, research and assign that grade next saves the user resources by preventing the user from wasting resources on researching and determining less influential grades. Accordingly, the present invention identifies for the user the candidate and criterion associated with the grade to be researched next.

In the preferred embodiment, this method of choosing the next grade to research and assign is built into the process outlined by way of example in FIG. 3 and FIG. 4. However, on alternate embodiments, this portion of the method can be treated as optional or not be present at all.

As mentioned above, the method of the present invention is typically carried out on a processing platform with the generated outputs (i.e., scores) being made available to an end user. If the user is a human, the scores could be output to some type of output device for presentation in a discernable format. If the user is an application or system that uses the scores, the data form of the scores could be made available thereto. By way of example, FIG. 6 illustrates an embodiment of a system 10 that can be used to carry out the method of the present invention. System 10 includes a user input device 12, a processor 14, and an output receiver 16. User input device 12 serves as the supply entity for candidates, criteria, weights and grade lists for each of the candidates. Such supply can involve manual entry of data, some type of automated entry of data, or a combination of the two. Processor 14 is any device/system capable of carrying out the process steps of the present invention explained previously herein. For example, if the present invention were to be offered to users via the internet, user input device 12 could be a user's computer terminal and processor 14 could be remotely located at an offerer's server. Output receiver 16 is any device that can use and/or present the outputs generated by processor 14. In the case where a human is to be presented with the results of the present invention, output receiver 16 can be a display device that presents the user with, at a minimum, the scores for at least one of the candidates in some format that can be understood by the user. Additionally, output receiver 16 could be used to display candidates, criteria, weights and grades to present the user with a complete decision making “picture”. Output receiver 16 can be locally or remotely located with respect to processor 14. Again, in the case of an internet-based version of the present invention, output receiver 16 could be the user's computer that served as user input device 12.

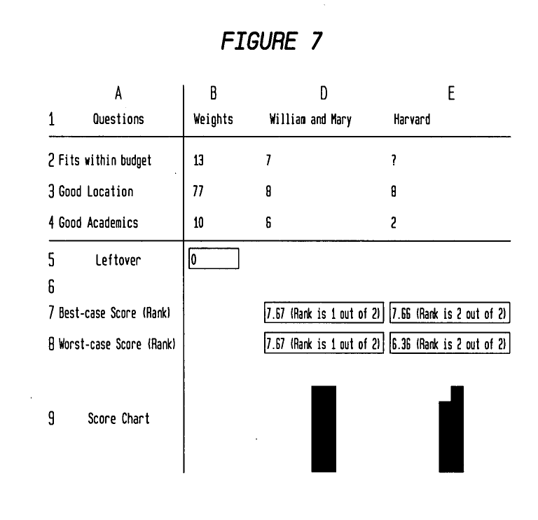

FIG. 7 shows an exemplary screen capture from a program performing MCDA with the addition of best-case and worst-case tracking in accordance with an embodiment of the present invention. Note that a cell E2 has not been researched or assigned, and its value is as yet unknown to the process. Nevertheless, a best-case and a worst-case score has been computed for each candidate. Even though the grade in cell E2 has not been assigned, it can be determined that a candidate William and Mary is the optimal choice. This is because the worst-case score of candidate William and Mary is better than the best-case score of all other candidates, which in this case is Harvard. In addition to determining the optimal candidate, the present embodiment also visually color-codes winning and loosing candidates.

The outputs can be presented as simple number scores as illustrated in the “Best-case Score” and “Worst-case Score” lines in FIG. 7. However, the number scores can also be used to generate (e.g., using processor 14) graphic elements such as bar graphs as shown on the “Score Chart” line in FIG. 7. A side-by-side presentation of the bar graphs (as shown) illustrating the worst-case and best-case scores relates the candidates' graphically for a quick understanding thereof.

Assigning a value to a previously unassigned grade will not increase that candidate's best-case score. Likewise, this will not decrease that candidate's worst-case score. Also, a candidate's best-case score will always be equal to or higher than that same candidate's worst-case score. Note that, in some embodiments, candidates may be populated into the MCDA system from the search results of a database search, and that this enhanced MCDA may be incorporated into search engines to assist with ranking search results.

An alternate embodiment may implement a method of taking intuition into account during either the traditional or enhanced MCDA method. Instead of treating intuition and final MCDA results as separate inputs into the final decision step, this embodiment includes intuition as a criterion in the traditional or enhanced MCDA process. Intuition is treated like other criteria by assigning it a weight and by researching and assigning grades. In this manner intuition can be quantitatively accounted for early on in the process. This will also allow quantifiable sensitivity analysis.

Another alternate embodiment implements a method of facilitating user insight and self-discovery by using the MCDA method. People seeking insight and self-discovery regarding complex situations may use either the traditional or the enhanced MCDA method. This method, especially the weight assignment and grading steps, walks them through careful consideration of the elements of a situation and gives them a framework for their thinking. Using an MCDA method can facilitate introspection, insight, self-discovery, and values clarification for people in complex situations, regardless of whether or not a decision is required.

Having fully described at least one embodiment of the present invention, other equivalent or alternative means for implementing an enhanced method for MCDA according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims. It is therefore to be understood that, within the scope of the appended claims, the invention may be practiced other than as specifically described.

What is claimed as new and desired to be secured by Letters Patent of the United States is:

1. A method of identifying a best candidate from a plurality of candidates, comprising the steps of:
providing a plurality of criterions for use in evaluating the candidates;
providing a weight for each of said plurality of criterions;
establishing, for each of the candidates, at least two grades for each of said plurality of criterions associated therewith;
generating, for each of the candidates, at least two weighted sums using said weight and said at least two grades for each of said plurality of criterions; and
presenting said weighted sums for at least one of the candidates to an end user.

2. A method according to claim 1 wherein, when a grade for one of said plurality of criterions for one of the candidates is known definitively, said at least two grades associated therewith are identical.

3. A method according to claim 1 wherein, when a grade for one of said plurality of criterions for one of the candidates is not known, said at least two grades associated therewith include a lowest possible grade and a highest possible grade for said one of said plurality of criterions, wherein said at least two weighted sums generated for said one of said one of the candidates include a lowest possible weighted sum incorporating said lowest possible grade and a highest possible weighted sum incorporating said highest possible grade.

4. A method according to claim 1 wherein said step of presenting includes the step of generating a bar graph from each of said weighted sums for said at least one of the candidates.

5. A method according to claim 1 wherein, prior to said step of presenting, said method further comprises the step of ordering the candidates based on said weighted sums.

6. A method according to claim 3 wherein, prior to said step of presenting, said method further comprises the step of ordering the candidates based firstly on said highest possible weighted sum for each of the candidates and secondly on said lowest possible weighted sum for each of the candidates.

7. A method according to claim 6 wherein said step of presenting includes the step of selecting said weighted sums for at least one of the candidates based on said step of ordering.

8. A method according to claim 3 wherein, for each of the candidates having said lowest possible weighted sum and said highest possible weighted sum associated therewith, said method further comprises the steps of:
selecting one of the candidates based firstly on said highest possible weighted sum and secondly on said lowest possible weighted sum; and
selecting, for said one of the candidates so-selected, one of said plurality of criterions associated therewith having said weight that is greatest to thereby define an optimal criterion that should be researched in order to establish a grade that is known.

9. A method of identifying a best candidate from a plurality of candidates, comprising the steps of:
providing a plurality of criterions for use in evaluating the candidates;
providing a weight for each of said plurality of criterions;
establishing, for each of the candidates, first and second grades for each of said plurality of criterions associated therewith, wherein said first and second grades are designated as assigned when a grade for a criterion is known and wherein said first and second grades are designated as unassigned when a grade for a criterion is unknown;
generating, for each of the candidates, first and second weighted sums using (i) said first and second grades, respectively, and (ii) said weight, for each of said plurality of criterions;
ordering the candidates based on said first and second weighted sums; and
presenting, based on said step of ordering, said first and second weighted sums for at least one of the candidates to an end user.

10. A method according to claim 9 wherein said step of presenting includes the step of generating a bar graph from each of said weighted sums for said at least one of the candidates.

11. A method according to claim 9 wherein, when said first and second grades are designated as unassigned, said first grade is greater than said second grade, wherein said first weighted sum is greater than said second weighted sum.

12. A method according to claim 11 wherein said first grade is a highest possible grade and said second grade is a lowest possible grade.

13. A method according to claim 11 wherein said step of ordering is based firstly on said first weighted sum and secondly on said second weighted sum.

14. A method according to claim 11 wherein, for each of the candidates having said first weighted sum greater than said second weighted sum, said method further comprises the steps of:
selecting one of the candidates based firstly on said first weighted sum and secondly on said second weighted sum; and
selecting, for said one of the candidates so-selected, one of said plurality of criterions associated therewith having said weight that is greatest to thereby define an optimal criterion that should be researched in order to establish a grade that is known.

15. A method of identifying a best candidate from a plurality of candidates, comprising the steps of:
providing a processing platform and an output receiver coupled thereto;
providing said processing platform with (i) the candidates, (ii) a plurality of criterions for use in evaluating the candidates, (iii) a weight for each of said plurality of criterions, and (iv) for each of the candidates, at least two grades for each of said plurality of criterions associated therewith;
generating, for each of the candidates, at least two weighted sums based on said weight and said at least two grades for each of said plurality of criterions using said processing platform; and
presenting said weighted sums for at least one of the candidates in a human discernable format to said output receiver.

16. A method according to claim 15 wherein, when a grade for one of said plurality of criterions for one of the candidates is known, said at least two grades associated therewith are identical.

17. A method according to claim 15 wherein, when a grade for one of said plurality of criterions for one of the candidates is unknown, said at least two grades associated therewith include a lowest possible grade and a highest possible grade for said one of said plurality of criterions, wherein said at least two weighted sums generated for said one of said one of the candidates include a lowest possible weighted sum incorporating said lowest possible grade and a highest possible weighted sum incorporating said highest possible grade.

18. A method according to claim 17 wherein said step of presenting includes the steps of:
generating a bar graph from each of said weighted sums for said at least one of the candidates using said processing platform wherein a plurality of bar graphs are generated for each of the candidates; and
displaying, for each of the candidates, said plurality of bar graphs in a side-by-side fashion using said output receiver.

19. A method according to claim 17 wherein, prior to said step of presenting, said method further comprises the step of ordering the candidates based firstly on said highest possible weighted sum for each of the candidates and secondly on said lowest possible weighted sum for each of the candidates using said processing platform.

20. A method according to claim 19 further comprising the step of selecting said weighted sums for at least one of the candidates used in said step of presenting based on said step of ordering.

21. A method according to claim 17 wherein, for each of the candidates having said lowest possible weighted sum and said highest possible weighted sum associated therewith, said method further comprises the steps of:
selecting one of the candidates based firstly on said highest possible weighted sum and secondly on said lowest possible weighted sum;
selecting, for said one of the candidates so-selected, one of said plurality of criterions associated therewith having said weight that is greatest, wherein said steps of selecting are accomplished using said processing platform; and
identifying, using said output receiver, said one of said plurality of criterions so-selected for said one of said candidates so-selected as being an optimal criterion that should be researched in order to establish a grade therefor that is known.
